(19) United States
(12) Patent Application Publication
(10) Pub. No.: US 2005/0199579 A1
(43) Pub. Date: Sep. 15, 2005

(54) Protective collar

(76) Inventor: Curt M. Novak, Naperville, IL (US)

Correspondence Address: CURT NOVAK, 1022 N MAIN ST, NAPERVILLE, IL, 60563, US

(21) Appl. No.: 11/078,818

(22) Filed: Mar. 11, 2005

Related U.S. Application Data
(60) Provisional application No. 60/552,053, filed on Mar. 11, 2004.

(51) Int. Cl. B67D 1/16; B65D 23/06

(52) U.S. Cl. 215/392

(57) ABSTRACT

An elastic cloth is circularly engaged using an affixing means to hold abutting ends together to form a protective collar. In a tubular fashion, the protective collar is elastically affixable over an elongated neck of a bottle and the elastic cloth allows for emulating the contours of the necks. The protective collar is held in place by the affixing means and in direct engagement of the neck to provide for protecting glassware from chipping based on accidental contact with the bottle neck and preventing undesirable liquid drips by catching an excess liquid spilling over the lip of the bottle. Also, the protective collar allows for a decorative addition to the bottle through the allowed placement of fanciful designs on the front thereon.

### RELATED APPLICATION

The present application claims priority to provisional application Ser. No. 60/552,053 having a filing date of Mar. 11, 2004.

### FIELD OF THE INVENTION

The present invention is directed to bottle accoutrements and more specifically to a device for protecting fine wares from damage.

### BACKGROUND OF INVENTION

Damage or ruin to fine glassware can be hazardous or costly and irreplaceable pieces destroyed. For example, when the edge of glassware becomes nicked, chipped or cracked it can induce harm to individuals consuming from or handling the neglected glassware. Such is the possibility when a sturdy vessel, such an elongated neck of a bottle, comes in contact with the fragile lip of glassware. Improper contact can quickly render a family heirloom or valuable glassware useless. Few, if any, viable solutions have been developed to protect the glassware from incidental contact with the bottle neck.

Other problems may arise when using a bottle having an elongated neck. When a liquid is poured out of the bottle, there exists the potential for excess liquid to collect at the opening. This excess liquid may then drip onto an exterior area, such as a table cloth or a persons clothing. This excess liquid may also run down the neck of the bottle, down the length of the bottle itself, marring the containers labeling and leaving a mark on a resting surface when the bottle is disposed in an upright position. Also, in more formal settings, it is undesirable to have a drip stain on the bottle and/or the bottle's labels.

Attempts have been made to resolve the above-noted concerns. For example, U.S. Pat. No. 134,302 uses a drip cup that has a channel area for inserting a cord or other absorbent material to catch a drip. This solution includes an outwardly extending drip cup and does not provide for softening a potential impact with a glass rim. In another example, U.S. Pat. No. 447,635 uses a piece of cloth affixed around a bottle collar with a metal strip in conjunction with a channel for catching any excess liquid. In another example, U.S. Pat. No. 571,088 uses an absorbent material held in place with a flexible band having teeth for embedding into the material. In another example, U.S. Pat. No. 657,327 uses a fastening device for securing the collar after it is wrapped around the neck of a bottle. U.S. Pat. No. 1,182,993 uses a band of textile material which requires the user to roll the edges inwardly when placing on the bottle in order to perform the task of absorption. A seemingly awkward solution that could prove difficult for many users.

In another example, U.S. Pat. No. 3,063,590 proposes a strip of fabric that wraps the neck of the bottle with mechanical closures needed for securing in place. Though able to accommodate different size containers, the agility needed for holding the band in place and keeping snug to the bottle while securing the closures could prove to be a bit tricky for the user. The end result would leave the loose ends of material exposed and bulk at the overlap. Also, this does not provide for impact resistance to protect glassware.

In another example, U.S. Pat. No. 6,325,247 uses a resolution comprised of a multi-layering of materials during manufacturing, within would reside an absorbent layer. The object itself is open-ended to adapt to bottle size. Leaving a void on larger bottles which would allow for the bypass of fluid through the said void or on smaller bottles a bulky overlap would be apparent. Additionally, it is adhered to the bottle with an adhesive, making this solution a more permanent part of the container once in place, whether affixed during manufacturing or by the user. Furthermore, the drip collar is exposed based on the removal of a cap of lid element on the bottle, whereupon the drip collar is affixed to the bottle and associated with the lid element directly.

### SUMMARY OF THE INVENTION

Generally, the present invention combines cleanliness with safety by offering a wrap that conforms to the contours of a fluid dispensing vessel's upper portions, thereby, concealing the vessels surfaces that would normally come in contact with the receiving receptacle, typically flush with the utmost top of the vessel. Upon said contact the wrap would absorb the impact. When the vessel's liquid contents is dispensed into the receiving receptacle any fluid that wicks up the dispensing vessel's lip will be contained by the absorbent impact wrap prior to the liquid forming into a drip.

### BRIEF DESCRIPTION OF DRAWINGS

FIG. 1 illustrates a perspective view of one embodiment of a protective collar relative to a bottle;

FIG. 2 illustrates a perspective view of one embodiment of the protective collar relative to the bottle in an alternate position;

FIG. 3 illustrates a perspective view of one embodiment of the protective collar relative to the bottle in another alternate position;

FIG. 4 illustrates the protective collar disposed on the bottle illustrated in FIG. 1, relative to a drinking glass;

FIG. 5 illustrates the protective collar according to one embodiment of the present invention;

FIG. 6 illustrates the protective collar of FIG. 5 with a cutout to illustrate an interior portion;

FIG. 7 illustrates the protective collar where opposing ends abut;

FIG. 8 illustrates the protective collar prior to assembly;

FIG. 9 illustrates a first step in one embodiment of assembling the protective collar;

FIG. 10 illustrates another step in one embodiment of assembling the protective collar;

FIG. 11 illustrates another step in one embodiment of assembling the protective collar; and

FIGS. 12-15 illustrate varying embodiments of the protective collar.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail. The embodiments disclosed and described herein are for exemplary purposes only and are not meant to be so limiting herein.

FIG. 1 illustrates the embodiment of the protective collar 1 applied to an elongated neck 2 of a fluid container 3. The protective collar 1 is composed of a band of elastic material and encompasses the neck 2 of the container 3. In the embodiment illustrated in FIG. 1, the protective collar 1 encompasses the lip 4 of the opening 5 of the container 3 covering the majority and or all of the neck 2.

The device 1 may be any suitable type of material, preferably but not limited to a content of synthetic compounds that enhance a textiles ability to stretch and conform to the exterior shape of the vessel 3. In the case of this invention synthetics polymer fibers would be suitable. The content of polymer fibers allows the protective collar 1 to expand to multiples of its manufactured form while maintaining integrity, and returning to its original manufactured form also maintaining its integrity.

Additionally, the synthetic compounds offer durability in manufacture; the material of the protective collar 1 can be tooled and assembled without additional steps of manufacturing to finish edges, as the material 9 with synthetic content has an inherent ability not to fray, unlike most other fabrics. In one embodiment, the material may be a cloth type material.

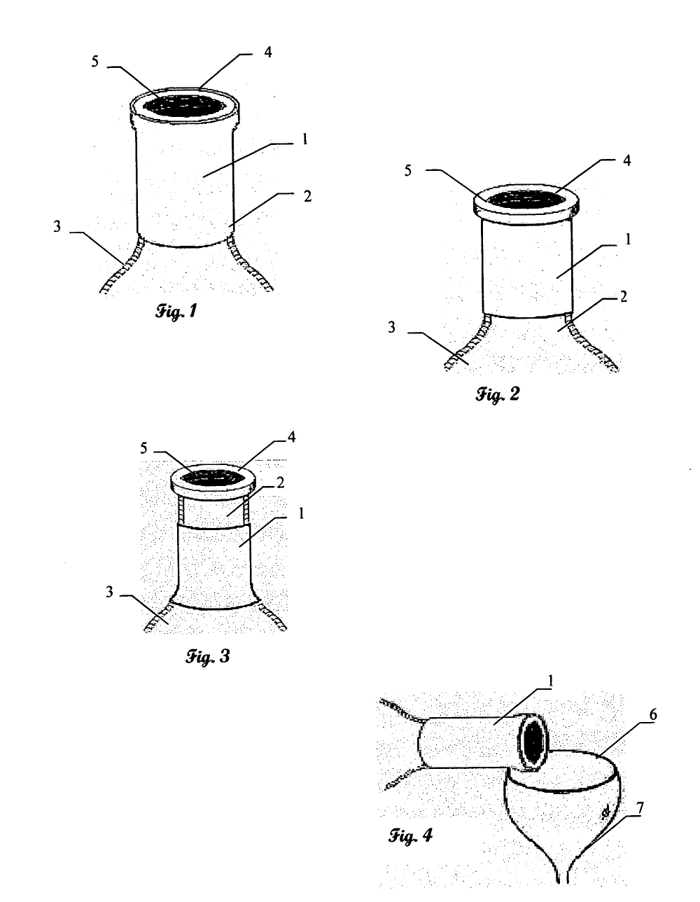

As discussed in further detail below, the material may be a single color, multi-colored, containing a particular design or any other suitable decorative aspects. In general, the device 1 encompasses the neck 2 of the container 5 for the purposes of catching any potential drips and serving to protect the accidental chipping of any barware that may contact the neck, as discussed below with regards to FIG. 4.

FIGS. 2 and 3 also illustrate varying locations of the disposition of the protective collar 1 on the neck 2 of the bottle 3. Based on the elasticity properties of the collar 1, the collar may be disposed just below the lip 4 of the opening 5, as illustrated in FIG. 2 or further down the neck 3 with a space between the lip 4 of the opening 5, as illustrated in FIG. 3. As illustrated in FIGS. 1-3, the protective collar 1 conforms to contours of the neck 2 regardless of its position. In FIG. 1, it emulates the contours of the lip 4 and neck 2, FIG. 2 it emulates the contours of the neck 2 and FIG. 3 it emulates the contours of the neck 2 and the fluted base of the neck.

FIG. 4 illustrates the protective collar 1 relative to a rim 6 of a piece of glassware 7. In FIG. 4, the protective collar 1 softens any impact to the glassware 7 when bottle comes in contact with rim 6. Thickness of the device 1 and types of material may differ but the presence of the collar protects from chipping the glassware 7 upon impact based on absorbing the impact and avoiding direct from the bottle neck and the rim 6. In one embodiment, the length of the device 1 may be adjustable based on the length of the neck, but the device may be any suitable length allowing for the protection of the rim 6 of the glassware 7.

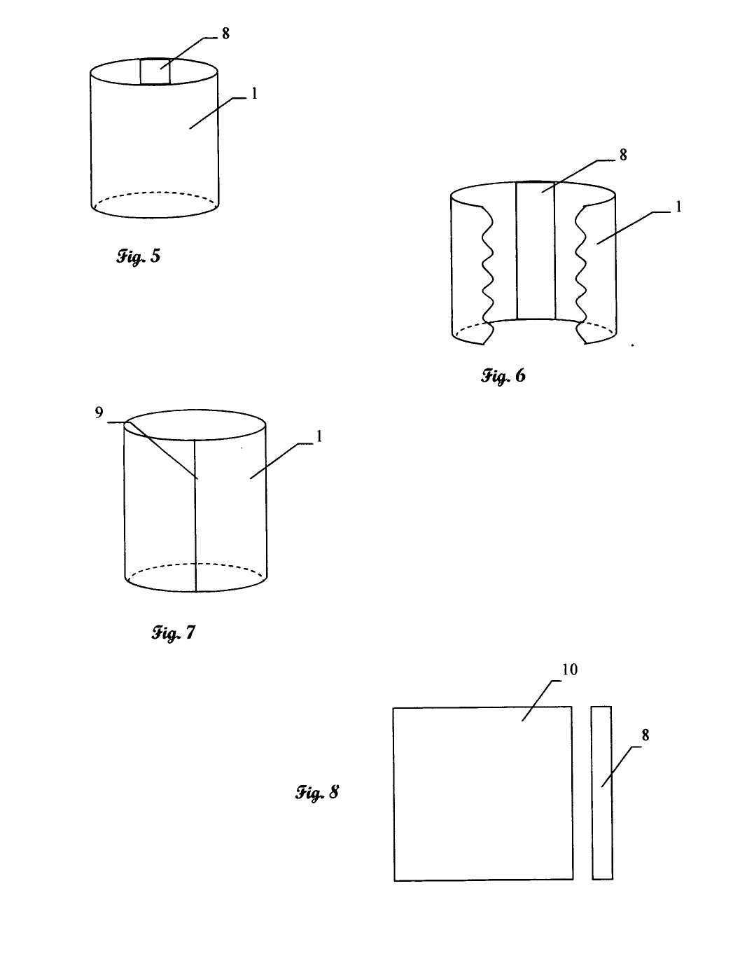

FIG. 5 illustrates the protective collar 1 not affixed to a bottle. In one embodiment, the device 1 includes an elastic textile material manufactured in any suitable manner resulting in a tubular form. The protective collar is maintained in a tubular or circular form with a connecting member 8 holding opposing ends of the collar together. Partially visible on the backside, the connection member 8 is a vertical splice, by way of a strap of material, any manner of attaching end to end. In one embodiment, not visible in FIG. 5, the attachment of the ends of the collar 1 leave an open flare allowing ease of placement.

FIG. 6 has a cut out portion of the protective collar 1 for a full view of connecting member 8 affixed to the interior. In one embodiment, the connecting member 8 may also be placed on the exterior. The connecting strip 8 may be comprised of a thin ribbon of material, in this case a textile. Applied to one surface of connecting strip 8 is a heat-seal product, this surface will come into contact with protective collar 1 at the abutted ends as shown and set in place with a heated iron.

FIG. 7 shows the exterior profile of protective collar 1 from the perspective of the two opposing ends 9 in direct contact for completing the circular collar 1. In one embodiment, this seam when completed is nearly indistinguishable, making the appearance of a seamless cylinder.

FIG. 8 gives the perspective of the device material 10 and the connecting strip 8 in there individual states prior to manufacture. While a heat-seal assembly has been described for the purpose of connecting strip 8 to device material 10 other assemblies, as permanent or less permanent, would be acceptable such as: pressure sensitive; hook and loop or uncut pile; snaps and or buttons and other such materials that would result in forming a tube of material. It is assumed all exposed edges will be of a finished appearance. Preferential properties of the material of device 1 would include: one-time-use allowing for disposal when soiled and/or reducing the passing of germs from user to user when handled; absorbent for purpose of capturing miss-distributed contents of a container; and substantial enough to cushion impacts. Printable materials would be an attribute for use as an advertising vehicle, personalization, or as a decoration.

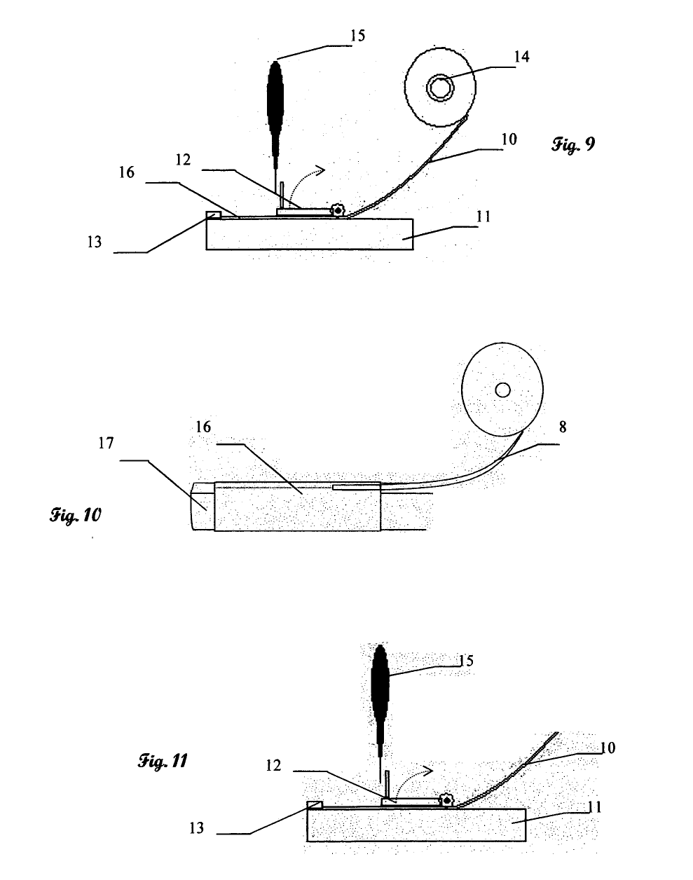

FIG. 9-FIG. 11 illustrates a method by which Device 1 may be manufactured.

FIG. 9 illustrates the device material 10 being fed from a freely rotating pipe 14 and fed through a hinged guide plate 12 in its cutting position—in neutral position it would be at a right angle to the scoring surface 11. The device material 10 is fed to the stop 13. A cutting device 15 such as a rotary knife is the run the length of the hinged guide 12. The distance between the stop 13 and the hinged guide 12 is the device material strip 16 which is the preferred circumference of the device material 10 now ready to be further manufactured.

FIG. 10 illustrates the device material strip 16 formed around a mandrel 17 with opposing ends abutting to form a tube. The connecting strip 8 is fed off a reel and covers the seam, preferably having the seam of the material strip 16 positioned to the center of the connecting tape 8. The connecting strip with a heat-seal backing can be attached by applying an iron at a pressure and length of time that will insure optimal adhesion. The material strip 16 now in tube form can be pulled off the mandrel for further processing.

FIG. 11 illustrates the material strip 16 in tube form can be reduced in size to fit it's application be sliding under hinged guide plate 12 on top of scoring surface 11 till reaching stop 13. The distance between hinged guide plate 12 and stop 13 would be the preferred length of collar 1. The material strip 16 in tube form is then scored with a blade 15 that is held flush to the hinged guide 12. The piece remaining is collar 1.

As described above, the protective collar may be assembled using the process illustrated in FIGS. 9-11. Although, as recognized by one having ordinary skill in the art, any other suitable assembly means may be readily envisioned and provide for generating the protective drip collar of the present invention.

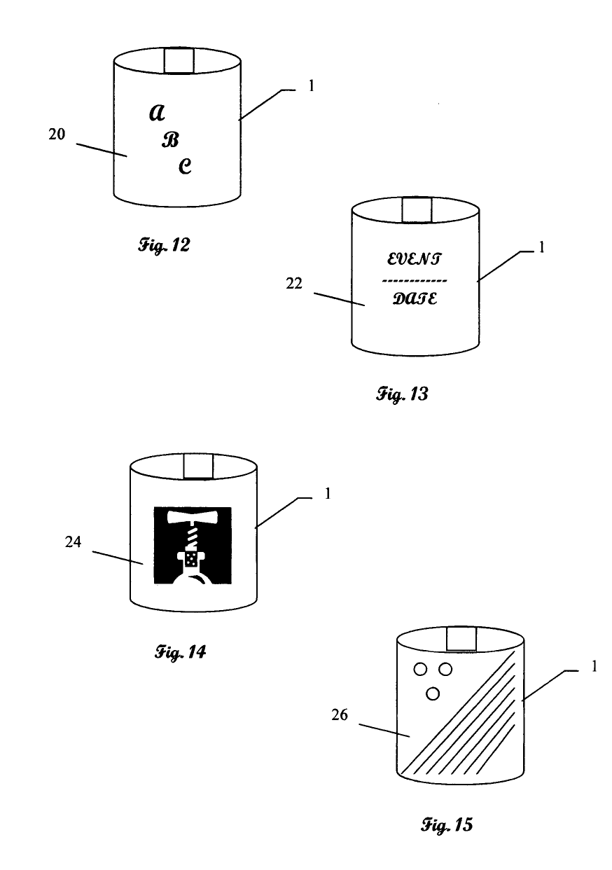

As noted above, the drip collar may also provide a platform for unique or characteristic designs. Based on the exposed area on the front of the drip collar, this exposed area may be used to provide any number of visual displays. FIGS. 12-15 illustrate representative displays of protective collars 1 having visual displays imprinted thereon.

For example, FIG. 12 illustrates the protective collar 1 having letters 20, such as a monogram, on the front. In one embodiment, a user may have the letter emblazoned on the protective collar 1 to provide an individual style. It is recognized that the monogram 20 is illustrated with three representative letters, but any suitable combination of letters, numbers, symbol, etc. may be affixed thereon. It is also noted that any suitable means may be used to affix monogram thereon, including generated material (10 of FIG. 8) with the monogram 20 printed thereon, stitched-on lettering, press-on lettering or any other suitable means.

FIG. 13 illustrates another embodiment of decorative embellishments for the protective collar 1. On the front portion, a commemorative event 22 may be designated with an appropriate date. For example, protective collars may be utilized for a wedding in conjunction with wine served thereat. On the protective collars, the name of bride and groom and the date may be affixed, similar to manners provided to affix the monogram illustrated in FIG. 12.

FIG. 14 illustrates yet another embodiment of decorative embellishments for the protective collar 1. On the front portion, a logo 24 or other distinguishing feature may be disposed. For example, a company hosting a corporate event may include protective collars having the company logo. In another example, a wine manufacturer may be include their logo on the protective collar. In another example, a logo or other indicator may be used to distinguish a particular bottle's contents such as at a wine-tasting event, the protective collar providing secondary indication of the wine. On the protective collars 1, any logo 24 may be affixed similar to manners provided to affix the monogram illustrated in FIG. 12.

FIG. 15 illustrates yet another embodiment of decorative embellishments for the protective collar 1. On the collar 1, a design 26 may be utilized to provide pizzazz. Any suitable design may be utilized, such as seasonal designs associated with holidays, for example red and green designs around Christmas, red white and blue around the 4^{th} of July, etc. On the protective collars 1, any design 26 may be affixed similar to manners provided to affix the monogram illustrated in FIG. 12.

It should be understood that the implementation of other variations and modifications of the invention and its various aspects will be apparent to those of ordinary skill in the art, and that the invention is not limited by the specific embodiments described herein. For example, the device 1 may be composed of multiple different types of materials and including various accoutrements, including, but not limited to, beads, jewels, or any other suitable decorative elements. It is therefore contemplated to cover by the present invention, any and all modifications, variations, or an equivalent that follows in the spirit and scope of the basic underlying principles disclosed herein.

1. A protective collar comprising:
a single band of elastic material having opposing ends;
a connecting means; and
the first end engaged next to the second end and secured in place using the connecting means such that the single band of material circularly extends therearound to which the opposing ends are abutted and fused by a strip of material placed transversely across abutment forming an apparently seamless tube.

2. The protective collar of claim 1 further comprising:
a bottom portion of the single band of elastic material stretchable for contouring over a lip of an elongated neck.

3. The protective collar of claim 2 further comprising:
a middle portion of the single band of elastic material stretchable for contactingly engaging contours of the elongated neck.

4. The protective collar of claim 3 further comprising:
a top portion of the single band of elastic material stretchable for contactingly engaging contours of a top portion of the elongated neck.

5. The protective collar of claim 3 wherein the protective collar, when disposed around an elongated neck is operative to collect any fluid emanating from the lip.

6. The protective collar of claim 3 further comprising:
a top portion of the single band of elastic material stretchable for contactingly engaging the lip of the elongated neck.

7. The protective collar of claim 3, the middle portion including an exposure area for the disposition of a display.

8. The protective collar of claim 1, when the protective collar is disposed on an elongated neck, the elastic material providing a cushion for an impact between the elongated neck and a glassware rim.

9. A protective collar for a bottle having an elongated neck, the protective collar comprising:
a single band of elastic material having opposing ends, a bottom portion, a middle portion and a top portion;
a connecting means such that the first end engaged next to the second end and secured in place using the connecting means such that the single band of material circularly extends therearound to which the opposing ends are abutted and fused by a strip of material placed transversely across abutment forming an apparently seamless tube;
the bottom portion of the single band of elastic material stretchable for contouring over a lip of the elongated neck;
the middle portion of the single band of elastic material stretchable for contactingly engaging contours of the elongated neck;
the top portion of the single band of elastic material stretchable for contactingly engaging contours of a top portion of the elongated neck;
and the top, middle, and bottom portions of a single band of elastic material stretchable for contactingly engaging varying sizes of a vessel's upper portions.

10. The protective collar of claim 9 wherein the protective collar, when disposed around the elongated neck is operative to collect any fluid prior to forming a drip and or any drips emanating from the lip.

11. The protective collar of claim 9 further comprising:
the top portion of the single band of elastic material stretchable for contactingly engaging the lip of the elongated neck trapping fluid prior to forming a drip.

12. The protective collar of claim 9, the middle portion including an exposure area for the disposition of a display.

13. The protective collar of claim 12 wherein the display is at least one of: a monogram, a design, a logo, a trademark and a descriptive phrase.

14. The protective collar of claim 9, the elastic material providing a cushion for an impact between the elongated neck and a glassware rim.

15. A protective collar made by the process comprising:
feeding elastic material from a rotating pipe through a hinged guide plate to a stop;
running a cutting device the length of the hinged guide;
forming the elastic material around a mandrel with opposing ends of the material abutting to form a tube;
feeding a connecting strip over the opposing ends;
securing the connecting strip to form an adhesion;
scoring the elastic material strip with a blade that is held flush to the hinged guide to form the protective collar.

16. The protective collar of claim 15 wherein the cutting device is a rotary knife.

17. The protective collar of claim 15 wherein the length of elastic material fed from the rotating pipe indicates substantially the circumference of the protect collar.

18. The protective collar of claim 15 wherein the connecting strip Is fed from a reel.

19. The protective collar of claim 15 wherein the connecting strip is a heat-seal backing tape.

20. The protective collar of claim 19 made by the process further comprising: applying an iron over the heat-seal backing tape.
